(19) United States
(12) Patent Application Publication
(10) Pub. No.: US 2019/0347753 A1
(43) Pub. Date: Nov. 14, 2019

(54) DATA PROCESSING METHOD, APPARATUS AND DEVICE, AND COMPUTER-READABLE STORAGE MEDIUM

(71) Applicant: BEIJING XIAODU INFORMATION TECHNOLOGY CO., LTD., Beijing (CN)

(72) Inventors: Shaojian HUANG, Beijing (CN); Mingquan XU, Beijing (CN); Congyu WANG, Beijing (CN); Fada YE, Beijing (CN); Jinqing CHEN, Beijing (CN); Ke XIAN, Beijing (CN); Qiuyuan YANG, Beijing (CN)

(21) Appl. No.: 16/520,021

(22) Filed: Jul. 23, 2019

Related U.S. Application Data
(63) Continuation of application No. PCT/CN2017/096001, filed on Aug. 4, 2017.

(30) Foreign Application Priority Data
Jan. 26, 2017 (CN) 201710061837.0

(51) Int. Cl. G06Q 50/28; G06Q 10/06

(52) U.S. Cl. CPC G06Q 50/28; G06Q 10/063116; G06Q 10/063114

(57) ABSTRACT

Embodiments of this disclosure provide a data processing method, apparatus, and device, and a computer readable storage medium. In the embodiments of this disclosure, an unassigned order group of each of at least two distribution services is obtained; a status indicator of a distribution person is determined; a distribution indicator of the unassigned order group is determined; and the unassigned order group is assigned to a matched distribution person based on the distribution indicator and the status indicator. In this way, distribution orders of at least two distribution services can be jointly scheduled, thereby reducing distribution costs, saving distribution resources, and increasing a distribution resource utilization rate.

### CROSS-REFERENCE TO RELAYED APPLICATION

This application is a continuation application of International Patent Application No. PCT/CN2017/096001, filed on Aug. 4, 2017, which is based on and claims priority of the Chinese Patent Application No. 201710061837.0, filed on Jan. 26, 2017 and entitled “DATA PROCESSING METHOD, APPARATUS AND DEVICE, AND COMPUTER-READABLE STORAGE MEDIUM.” The above-referenced applications are incorporated herein by reference in their entirety.

### TECHNICAL FIELD

Embodiments of this disclosure relate to the field of computer application technologies, and in particular, to a data processing method, apparatus, and device, and a computer readable storage medium.

### BACKGROUND

The arrival of the e-commerce era drives rapid development of the logistics service. To meet different distribution requirements, distribution businesses that provide logistics service are increasingly diversified.

Participation from distribution persons is required in distribution scheduling of a distribution business, and the distribution persons need to perform operations such as a pickup and/or a delivery according to a distribution order. Different distribution businesses may have different distribution requirements, which may result in different distribution scheduling. Consequently, each conventional distribution business uses its own distribution persons for distribution scheduling, which undoubtedly increases distribution costs, and causes a waste of distribution resources.

### SUMMARY

Currently, a distribution business uses its own dedicated distribution persons for distribution scheduling to meet its distribution requirements. To ensure service quality of various distribution businesses, distribution persons are generally deployed to meet the greatest possible distribution demand, which may result in redundant distribution persons in ordinary condition and may lead to a waste of distribution resources. Moreover, distribution scheduling of current distribution businesses is mostly performed by manually sorting distribution orders. This imposes a relatively high requirement on experience of distribution persons and is prone to errors, which may affect distribution efficiency.

To resolve the foregoing technical problem, embodiments of this disclosure provide a data processing method, apparatus, and device, and a computer readable storage medium, to reduce distribution costs, increase a distribution resource utilization rate, and ensure distribution efficiency.

According to a first aspect of the embodiments of this disclosure, a data processing method is provided. The data processing method may include obtaining an unassigned order group for each of at least two distribution businesses, and the unassigned order groups may each comprise at least one distribution order.

The data processing method may further include determining a status indicator for each of one or more distribution persons, determining a distribution indicator for each of the unassigned order groups, and assigning each of the unassigned order groups to a matched distribution person from the one or more distribution persons based on the distribution indicators and the status indicators. The assigning an unassigned order group to a matched distribution person from the one or more distribution persons may include computing, based on the status indicators and the distribution indicators, a matching score between the unassigned order group and each of the one or more distribution persons; and assigning, based on the matching scores, the unassigned order group to the matched distribution person.

Optionally, the assigning the unassigned order group to the matched distribution person from the one or more distribution persons may include determining, based on the status indicators and the distribution indicators, the matched distribution person for the unassigned order group, and, in response to a determining result that the unassigned order group meets a scheduling condition, assigning the unassigned order group to the matched distribution person.

Optionally, the method may further include adding an unassigned order group similar to an assigned order group of a distribution person into the assigned order group according to a distance between a start address of the assigned order group and a start address of the unassigned order group, and a distance between a destination address of the assigned order group and a destination address of the unassigned order group.

Optionally, the at least two distribution businesses may comprise a first distribution service and a second distribution service.

Optionally, the distribution type of the first distribution service may include a delivery type in which a distribution object is collected from a distribution center and delivered to a recipient, and a pickup service in which a distribution object is collected from a sender and delivered to the distribution center. The second distribution service may have a distribution type in which a distribution object may be received from a sender and delivered to a recipient.

Optionally, the obtaining an unassigned order group of the first distribution service may include selecting a cluster center order according to a distance between a user address of each ungrouped distribution order of the first distribution service and an address of the distribution center, and performing a clustering process according to a distance between the user address of each ungrouped distribution order and a user address of the cluster center order, to obtain the unassigned order group corresponding to the cluster center order.

Optionally, the obtaining an unassigned order group of the second distribution service may include determining a start address, a destination address, and an expected completion time for each unassigned distribution order of the second distribution service, and grouping unassigned distribution orders into the unassigned order group of the second distribution service. A distance between start addresses of any two distribution orders in the unassigned order group may be less than a first distance. A distance between destination addresses of any two distribution orders in the unassigned order group may be less than a second distance, and a time difference between expected completion times of any two distribution orders in the unassigned order group may be less than a preset time.

Optionally, the distribution indicator may include a start address, a destination address, and an expected completion time. Determining a distribution indicator for an unassigned order group of the first distribution service may include assigning an earliest expected completion time of all distribution orders in the unassigned order group to an expected completion time of the unassigned order group, and scheduling, according to user addresses of the distribution orders in the unassigned order group and an address of the distribution center, an estimated distribution sequence of the distribution orders in the unassigned order group.

The determining a distribution indicator for an unassigned order group of the first distribution service may further include: for the pickup type first distribution service, assigning a start address of a distribution order whose distribution is first performed to a start address of the unassigned order group, and using the address of the distribution center to a destination address of the unassigned order group; and, for the delivery type first distribution service, assigning the address of the distribution center as a start address of the unassigned order group, and assigning a destination address of a distribution order whose distribution is last performed to a destination address of the unassigned order group.

Determining a distribution indicator for an unassigned order group of the second distribution service may include: assigning an earliest expected completion time of distribution orders in the unassigned order group to an expected completion time of a distribution person corresponding to the unassigned order group; scheduling, according to start addresses and destination addresses of the distribution orders in the unassigned order group and an estimated distribution location of each distribution person, an estimated distribution sequence for each distribution person corresponding to the distribution orders; and assigning a start address of a distribution order whose distribution is first performed to a start address of each distribution person corresponding to the unassigned order group, and assigning a destination address of a distribution order whose distribution is last performed to a destination address of each distribution person corresponding to the unassigned order group.

Optionally, the status indicator of a distribution person may include an estimated distribution time and an estimated distribution location. The assigning an unassigned order group to a matched distribution person based on the distribution indicators and the status indicators may include: calculating a matching score between the unassigned order group and each distribution person according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group; and assigning, based on the matching scores, the unassigned order group to the matched distribution person.

Optionally, assigning an unassigned order group to a matched distribution person based on the distribution indicators and the status indicators may include: treating the unassigned order group as the N^{th} to-be-determined unassigned order group, and determining, from to-be-determined distribution persons, the distribution person who has a highest degree of matching with the unassigned order group to obtain M matching lists. N is a total number of unassigned order groups and is an integer greater than or equal to 1, and M is an integer greater than or equal to 1; for each of the M matching lists, calculating a sum of the matching scores corresponding to all unassigned order groups to obtain a list score for each matching list; and assigning, based on a matching list with a highest list score, the unassigned order group to a corresponding distribution person.

Optionally, determining the estimated distribution time and the estimated distribution location of a distribution person may include: assign, according to an assigned order group that is of the distribution person and whose distribution is currently uncompleted, an estimated completion time of the assigned order group to the estimated distribution time, and a destination address of the assigned order group to the estimated distribution location.

Optionally, determining an estimated completion time of a distribution person completes distribution of an unassigned order group may comprise: determining, according to a distribution path of the unassigned order group, a moving speed of the distribution person, and a user waiting time of each distribution order in the unassigned order group, an estimated order completion time of each distribution order; and calculating, according to the order completion times, the estimated completion time of the unassigned order group.

Optionally, after the assigning the unassigned order group to a matched distribution person based on the distribution indicators and the status indicators, the method may further include: determining the estimated order completion time of each distribution order in the assigned order group; and sending the order completion time of each distribution order to a sender terminal or a recipient terminal corresponding to the distribution order.

Optionally, the method may further include: calculating, based on a distance between start addresses and a distance between destination addresses, a degree of order similarity between an assigned order group of each distribution person and each of the unassigned order group of the first distribution service and the unassigned distribution order of the second distribution service; and adding, into the assigned order group, an unassigned order group that is of the first distribution service and whose degree of order similarity is greater than a similarity threshold and/or an unassigned distribution order that is of the second distribution service and whose degree of order similarity is greater than the similarity threshold.

According to a second aspect of the embodiments of this disclosure, a data processing apparatus is provided. This data processing apparatus may include: an order obtaining module, configured to obtain an unassigned order group for each of at least two distribution businesses. The unassigned order groups may each comprise at least one distribution order.

The apparatus may further comprise a first indicator determining module, configured to determine a status indicator for each of one or more distribution persons; a second indicator determining module, configured to determine a distribution indicator for each of the unassigned order groups; and a first order assigning module, configured to assign each of the unassigned order groups to a matched distribution person from the one or more distribution persons based on the status indicators and the distribution indicators. The first order assigning module may be configured to compute, based on the status indicators and the distribution indicators, a matching score between the unassigned order group and each of the one or more distribution persons; and assign, based on the matching scores, the unassigned order group to the matched distribution person.

Optionally, the first order assigning module may include: an order determining unit, configured to determine, based on the status indicators and the distribution indicators, the matched distribution person for the unassigned order group; and an order assigning unit, configured to: in response to a determining result that the unassigned order group meets a scheduling condition, assign the unassigned order group to the matched distribution person.

Optionally, the apparatus may further include a second order assigning module, configured to add an unassigned order group similar to an assigned order group of a distribution person into the assigned order group according to a distance between a start address of the assigned order group and a start address of the unassigned order group, and a distance between a destination address of the assigned order group and a destination address of the unassigned order group.

Optionally, the at least two distribution businesses include a first distribution service and a second distribution service. A distribution period of the first distribution service may be greater than a distribution period of the second distribution service, and the first distribution service and the second distribution service may have different distribution peak hours.

Distribution types of the first distribution service may include a delivery type in which a distribution object is collected from a distribution center and delivered to a recipient, and a pickup type in which a distribution object is collected from a sender and delivered to the distribution center. The second distribution service may have a distribution type in which a distribution object is received from a sender and delivered to a recipient.

Optionally, the apparatus may further include: a first order classification module, configured to select a cluster center order according to a distance between a user address of each ungrouped distribution order of the first distribution service and an address of the distribution center, and perform, according to a distance between the user address of each ungrouped distribution order and a user address of the cluster center order, a clustering process to obtain the unassigned order group corresponding to the cluster center order.

Optionally, the apparatus may further include: a second order classification module, configured to determine a start address, a destination address, and an expected completion time for each unassigned distribution order of the second distribution service, and classify unassigned distribution orders into the unassigned order group of the second distribution service. A distance between start addresses of any two distribution orders in the unassigned order group may be less than a first distance. A distance between destination addresses of any two distribution orders may be less than a second distance, and a time difference between expected completion times of any two distribution orders may be less than a preset time.

Optionally, the distribution indicator may include a start address, a destination address, and an expected completion time, and the first indicator determining module may include a first determining unit and a second determining unit.

The first determining unit may be configured to: for each unassigned order group of the first distribution service, assign an earliest expected completion time of distribution orders in the unassigned order group to an expected completion time of the unassigned order group; schedule, according to user addresses of the distribution orders in the unassigned order group and an address of the distribution center, an estimated distribution sequence of the distribution orders in the unassigned order group; for the pickup type first distribution service, assign a start address of a distribution order whose distribution is first performed to a start address of the unassigned order group, and assign the address of the distribution center to a destination address of the unassigned order group; and for the delivery type first distribution service, assign the address of the distribution center to a start address of the unassigned order group, and assign a destination address of a distribution order whose distribution is last performed to a destination address of the unassigned order group.

The second determining unit may be configured to: for each unassigned order group of the second distribution service, assign an earliest expected completion time of distribution orders in the unassigned order group to an expected completion time for a distribution person corresponding to the unassigned order group; schedule, according to start addresses and destination addresses of the distribution orders in the unassigned order group and an estimated distribution location of each distribution person, an estimated distribution sequence of each distribution person corresponding to the distribution orders; and assign a start address of a distribution order whose distribution is first performed to a start address of each distribution person corresponding to the unassigned order group, and assign a destination address of a distribution order whose distribution is last performed to a destination address of each distribution person corresponding to the unassigned order group.

Optionally, the status indicator of a distribution person may include an estimated distribution time and an estimated distribution location. The first order assigning module may include a first calculation unit and a first order matching unit.

The first calculation unit may be configured to calculate a matching score between the unassigned order group and each distribution person according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group.

The first order matching unit may be configured to assign, based on the matching scores, the unassigned order group to the matched distribution person.

Optionally, the first order matching unit may be configured to: for each unassigned order group, treat the unassigned order group as the N^{th} to-be-determined unassigned order group, and determine, from to-be-determined distribution persons, the distribution person who has a highest degree of matching with the unassigned order group to obtain M matching lists. N is a total number of unassigned order groups and is an integer greater than or equal to 1, and M is an integer greater than or equal to 1; for each of the M matching lists, calculate a sum of the matching scores corresponding to all unassigned order groups to obtain a list score for each matching list; and assign each unassigned order group to a corresponding distribution person based on a matching list with the best list score.

Optionally, the second indicator determining module may be configured to assign, according to an assigned order group that is of the distribution person and whose distribution is currently uncompleted, an estimated completion time of the assigned order group to the estimated distribution time, and a destination address of the assigned order group to the estimated distribution location.

Optionally, the apparatus may further include a first time determining module and a second time determining module.

The first time determining module may be configured to determine, according to a distribution path of each unassigned order group, a moving speed of the distribution person, and a user waiting time of each distribution order in the unassigned order group, an estimated order completion time of each distribution order.

The second time determining module may be configured to calculate, according to the order completion time, the estimated completion time of the unassigned order group.

Optionally, the apparatus may further include a third time determining module and a time reminding module.

The third time determining module may be configured to determine an estimated order completion time of each distribution order in the assigned order group. The time reminding module may be configured to send the order completion time of each distribution order to a sender terminal or a recipient terminal corresponding to the distribution order.

Optionally, the apparatus may further include a similarity degree calculation module and a third order assigning module.

The similarity degree calculation module may be configured to compute, based on a distance between start addresses and a distance between destination addresses, a degree of order similarity between an assigned order group of each distribution person and each of the unassigned order group of the first distribution service and the unassigned distribution order of the second distribution service.

The third order assigning module may be configured to add, into the assigned order group, an unassigned order group of the first distribution service whose degree of order similarity is greater than a similarity threshold and/or an unassigned distribution order that is of the second distribution service whose degree of order similarity is greater than the similarity threshold.

According to a third aspect of the embodiments of this disclosure, a data processing device is provided, including a processing component and a storage component.

The storage component may be configured to store one or more computer instructions. The one or more computer instructions may be executed by the processing component to obtain an unassigned order group of each of at least two distribution businesses. The unassigned order groups may each comprise at least one distribution order.

The one or more computer instructions may be further executed by the processing component to determine a status indicator for each of one or more distribution persons; determine a distribution indicator for each of the unassigned order group; and assign, based on the status indicators and the distribution indicators, each of the unassigned order groups to a matched distribution person from the one or more distribution persons.

The assigning an unassigned order group to a matched distribution person from one or more distribution persons may include computing, based on the status indicators and the distribution indicators, a matching score between the unassigned order group and each of the one or more distribution persons; and assigning, based on the matching scores, the unassigned order group to the matched distribution person.

According to the embodiments of this disclosure, distribution orders of at least two distribution services can be jointly scheduled, so that the at least two distribution services may share a same batch of distribution persons. This reduces distribution costs, makes full use of distribution persons to avoid a waste of distribution resources, implements automatic distribution scheduling of distribution orders without resorting to manual sorting, and ensures distribution efficiency.

These aspects of this disclosure will be described in details in the following embodiments.

### BRIEF DESCRIPTION OF THE DRAWINGS

To describe the embodiments of this disclosure or related technologies more clearly, the accompanying drawings describing the example embodiments or the related technologies are briefly described below. Apparently, the accompanying drawings in the following description show only some example embodiments of this disclosure, and a person of ordinary skill in the art may still derive other drawings from these accompanying drawings without creative efforts.

FIG. 1 is a flowchart of a data processing method according to one embodiment of this disclosure.

FIGS. 2A and 2B are flowcharts of a data processing method according to one embodiment of this disclosure.

FIG. 3 is a schematic structural diagram of a data processing apparatus according to one embodiment of this disclosure.

FIG. 4 is a schematic structural diagram of a data processing apparatus according to one embodiment of this disclosure.

FIG. 5 is a schematic structural diagram of a data processing device according to one embodiment of this disclosure.

### DETAILED DESCRIPTION OF THE EMBODIMENTS

Embodiments of the technical solutions of this disclosure will be clearly and completely described below with reference to the accompanying drawings.

Some procedures described in the specification, claims, and accompanying drawings of this disclosure include a plurality of operations that may appear in a specific order. However, it should be clearly understood that these operations may be performed not in the order in which the operations appear in this specification, or may be performed in parallel. Sequence numbers such as 101 and 102 of operations are merely used to distinguish different operations. The sequence numbers themselves do not represent any execution order. In addition, these procedures may include more or fewer operations, and these operations may be performed sequentially or simultaneously. It should be noted that description such as “first” or “second” in this specification is used to distinguish different messages, devices, modules, or the like, which neither represents a sequence, nor imposes a limitation that the “first” and the “second” are different types.

Distribution businesses that provide logistics service are increasingly diversified. Generally, a distribution business may, based on its own dedicated distribution persons, perform distribution scheduling to meet different distribution requirements. In this disclosure, two common distribution businesses are used as examples. For ease of description, these two distribution businesses are named a first distribution service and a second distribution service, respectively. Distribution types of the first distribution service may include a pickup type and a delivery type. The pickup type first distribution service may include collecting a distribution object from a sender and delivering the distribution object to a distribution center. The delivery type first distribution service may include collecting a distribution object from a distribution center and delivering the distribution object to a recipient. Therefore, a distribution order of the first distribution service may be a pickup order or a delivery order, and a distribution operation of the first distribution service may be a pickup operation or a delivery operation. In an actual application, for example, the first distribution service may include warehouse-to-home delivery. A regular courier service is a typical warehouse-to-home delivery. For the pickup type distribution, distribution objects obtained from senders may all be delivered to a distribution center for further distribution. For the delivery type distribution, distribution objects may be collected from a distribution center and distributed to their corresponding recipients. The distribution objects may be various articles, and more specifically, may be merchandizes from online transactions.

A distribution type of the second distribution service may comprise receiving a distribution object from a sender and distributing the distribution object to a recipient. The distribution may be performed according to an expected completion time. Distribution operations of the second distribution service may include a pickup operation and a delivery operation. In an actual application, for example, take-out distribution in Online-To-Offline (O2O)-based take-out applications is a typical application of the second distribution service.

The first distribution service and the second distribution service may have different distribution peak hours. For example, for the warehouse-to-home distribution service and the take-out distribution service, distribution peak hours for the warehouse-to-home distribution service may be 08:00 to 11:00 every day, with peak pickup hours between 07:00 to 09:00 every day. The distribution peak hours for the take-out distribution service may be 11:00 to 13:00 and 17:00 to 19:00, coincident with peak dinning hours. For each of the aforementioned distribution services, manpower prepared for distribution peak hours may become redundant during distribution off-peak hours, which is a waste of resources and a main cause of high distribution costs.

Other than difference distribution peak hours, different distribution businesses may also have different requirements on the timeliness of a delivery. For example, the first distribution service and the second distribution service may have different distribution periods. A distribution period of a distribution order of the first distribution service may be greater than a distribution period of a distribution order of the second distribution service.

A distribution period may be a time length from a moment when a distribution order is generated to a moment when the distribution order is completed (the distribution object is delivered). The distribution period of the distribution order of the first distribution service may be greater than the distribution period of the distribution order of the second distribution service, which indicates that distribution timeliness of the first distribution service may be lower than that of the second distribution service. For example, a distribution order of the first distribution service may need to be completed within 24 hours starting from a moment the order is generated, and a distribution order of the second distribution service may need to be completed within half an hour starting from a moment the order is generated. Therefore, by jointly scheduling distribution orders from different distribution businesses according to their different distribution peak hours and different timeliness requirements, the number of distribution persons needed to complete these distribution orders may be reduced, which in turn reduces the distribution cost. Based on this inventive concept, this specification provides a data processing method, apparatus, and device, and a computer readable storage medium, to jointly schedule different distribution orders, which results in reduced cost and increased utilization rate of distribution resource.

Embodiments of the technical solutions of this specification are clearly and completely described below with reference to the accompanying drawings. Apparently, the described embodiments are merely some but not all of the embodiments of this disclosure. All other embodiments obtained by a person skilled in the art based on the embodiments of this disclosure without creative efforts shall fall within the protection scope of this disclosure.

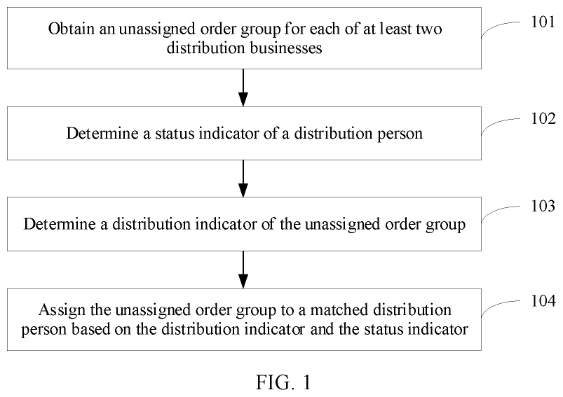

FIG. 1 is a flowchart of a data processing method according to one embodiment of this disclosure. Referring to FIG. 1, the method may include the following steps 101 through 104.

In step 101, an unassigned order group for each of at least two distribution businesses may be obtained. The at least two distribution businesses may include, for example, a first distribution service and a second distribution service.

In some embodiments, an unassigned order group for a distribution business may be obtained by grouping unassigned distribution orders. A distribution business may include one or more unassigned order groups.

Distribution scheduling may be performed for distribution orders of two or more different distribution businesses according to an actual requirement.

An unassigned order group may include at least one distribution order.

A distribution business may include many distribution orders to be scheduled. For optimized scheduling effect and improved distribution efficiency, distribution orders of each distribution business may be grouped into unassigned order groups, so that distribution orders in each unassigned order group may have close start addresses, close destination addresses, and/or close expected completion times. For example, for distribution orders in a same unassigned order group, a distance between start addresses of any two distribution orders may be less than a first distance, a distance between destination addresses of any two distribution orders may be less than a second distance, and a time difference between expected completion times of any two distribution orders may be less than a preset time. A specific distribution order grouping scheme is described in details in the following embodiments.

An expected completion time of a distribution order of the first distribution service may be an expected arrival time when a distribution object is delivered to a recipient or an expected receiving time when a distribution object is received from a sender. An expected completion time of a distribution order of the second distribution service may be an expected arrival time when a distribution object is delivered to a recipient. For example, an expected completion time of a distribution order may be a specific moment (e.g., 08:40). The expected completion time may be provided by a user or set by a system according to a historical pattern. For example, because a distribution timeliness requirement of the first distribution service may be relatively low, delivery within a distribution period is acceptable and an expected completion time may be set to any moment within the distribution period. On the other hand, because a distribution timeliness requirement of the second distribution service may be relatively high, an expected completion time may be determined according to a time a distribution order is generated and maximum distribution duration of a distribution object. The maximum distribution duration may be calculated according to factors such as a longest distance between a recipient and a sender, a minimum moving speed of a distribution person.

Certainly, in a special case, each unassigned order group may include only one distribution order. That is, distribution orders of different distribution businesses do not need to be grouped and the technical solution in this disclosure may be used directly for joint scheduling.

In step 102, a status indicator of a distribution person is determined.

In some embodiments, the status indicator may include at least an estimated distribution location. The estimated distribution location may be a location of the distribution person at a moment when the distribution person can perform distribution.

The status indicator may further include an estimated distribution time. The estimated distribution time may be the moment when the distribution person can perform distribution (e.g., 08:00).

If the distribution person has no pending distribution order, the estimated distribution location may be a current location of the distribution person and the estimated distribution time may be a current moment. If there is a pending distribution order, the estimated distribution time may be a moment when distribution of the last distribution order is completed, and the estimated distribution location may be a location of the distribution person at the moment when the distribution of the last distribution order is completed.

In step 103, a distribution indicator of the unassigned order group is determined.

In some embodiments, the distribution indicator may include at least a start address.

An unassigned order group may include a plurality of distribution orders, and each distribution order may have a start address and a destination address. For example, for the first distribution service, if a distribution type is a pickup type, the start address may be an address of a sender and the destination address may be an address of a distribution center. If the distribution type is a delivery type, the start address may be an address of the distribution center and the destination address may be an address of a recipient. Certainly, in some special cases, a distribution order of the first distribution service cannot be properly completed (e.g., a distribution object cannot be properly delivered). In those cases, the start address and the destination address may both be an address of the distribution center. For the second distribution service, the start address may be an address of a sender and the destination address may be an address of a recipient. A start address of an unassigned order group may be a start address of a distribution order whose distribution will be first performed in the unassigned order group.

To further improve distribution accuracy, optionally, the distribution indicator may further include an expected completion time. For example, an earliest expected completion time of all distribution orders in an unassigned order group may be set as an expected completion time of the unassigned order group. Optionally, the distribution indicator may further include a destination address. For example, a destination address of an unassigned order group may be a destination address of a distribution order whose distribution is estimated to be last performed in the unassigned order group.

In step 104, the unassigned order group may be assigned to a matched distribution person based on the distribution indicator and the status indicator.

In some embodiments, an unassigned order group may be assigned to a matched distribution person according to a distance between a start address of the unassigned order group and an estimated distribution location of a distribution person. A closer distance indicates a higher degree of matching between the unassigned order group and the distribution person.

In some embodiments, to ensure distribution efficiency and an on-time distribution rate, only one unassigned order group may be assigned to each distribution person in a current distribution scheduling period.

In some embodiments, joint scheduling may be performed for distribution orders of at least two distribution businesses, and a same batch of distribution persons may be shared to greatly reduce distribution costs and balance distribution workload. A distribution order may be assigned to a suitable distribution person based on a distribution indicator and a status indicator. The scheduling may be automatic and may achieve maximum distribution efficiency, without resorting to manual sorting. When the at least two distribution businesses include the first distribution service and the second distribution service, because of their different distribution peak hours, distribution capacities for one distribution business may complement the other at different time periods, so that distribution workload may be more evenly distributed.

A matching score between an unassigned order group and a distribution person may be calculated according to the distribution indicator and the status indicator, so that an unassigned order group can be assigned to a matched distribution person according to the matching score.

Optionally, based on the matching scores, each unassigned order group may be assigned to a matched distribution person according to a globally optimal solution.

In some embodiments, assigning an unassigned order group to a distribution person according to the matching scores may include the following steps.

First, assuming there are N unassigned order groups, the unassigned order group may be treated as the N^{th} to-be-determined unassigned order group, and a distribution person that has the highest degree of matching with the unassigned order group may be determined from the to-be-determined distribution persons. Since there are M (M≤N*(N−1)*(N−2)* . . . *1) different ways to go through N unassigned order groups, there will be M different matching lists, where N is a total number of unassigned order groups and is an integer greater than or equal to 1, M is an integer greater than or equal to 1, and M≤N*(N−1)*(N−2)* . . . *1.

Second, for each matching list, a sum of matching scores corresponding to all unassigned order groups may be calculated, which is a list score for each matching list.

Third, according to a matching list that has the best list score, each unassigned order group may be assigned to a corresponding distribution person.

For ease of understanding, the following example is used for description.

Assuming that there are two unassigned order groups A and B, and three distribution persons X, Y, and Z, a matching score between each of the two unassigned order groups and each of the three distribution persons may be calculated. It is assumed that a matching score between A and X is P_{AX}, a matching score between A and Y is P_{AY}, a matching score between A and Z is P_{AZ}, a matching score between B and X is P_{BX}, a matching score between B and Y is P_{BY}, and a matching score between B and Z is P_{SZ}.

When A is the first to-be-determined unassigned order group, a distribution person who has the highest degree of matching may be selected from X, Y, and Z according to the matching scores P_{AX}, P_{AY}, and P_{AZ}. It is assumed that the distribution person who has the highest degree of matching is X who has a matching score of P_{AX}. Since B is the second to-be-determined unassigned order group, and X has been selected for A, a distribution person who has the higher degree of matching for B may be selected from the to-be-determined distribution persons Y and Z. It is assumed that the distribution person who has the higher degree of matching is Z who has a matching score of P_{BZ}. In this case, a matching list is obtained: A is assigned to X, and B is assigned to Z. A sum of the matching scores of P_{AX} and P_{BZ} may be calculated, which is assumed to be R1 and may be used as a list score of the matching list.

Similarly, when A is the second to-be-determined unassigned order group, and B is the first to-be-determined unassigned order group, it is assumed that a corresponding matching list is: A is assigned to Y, and B is assigned to X. A sum of the matching scores of P_{AY} and P_{BZ} may be calculated, which is assumed to be R2 and may be used as a list score of the matching list.

Based on the above description, when A is the first to-be-determined unassigned order group, the distribution person X who has the highest degree of matching for A may first be selected from X, Y, and Z. Because B is the second to-be-determined unassigned order group, the distribution person Z who has the higher degree of matching for B can be selected only from Y and Z. When B is the first to-be-determined unassigned order group, the distribution person X who has the highest degree of matching for B may be selected from X, Y, and Z, and the distribution person Y who has the higher degree of matching for A may be selected only from Y and Z. Therefore, as can be seen from the above example, when unassigned order groups A and B are assigned in different orders, the corresponding matching lists may be different.

A matching list that has the best list score may be determined by comparing the list scores R1 and R2. Assuming that R2 is a better score, the assignment may be performed according to the matching list corresponding to R2. That is, A may be assigned to Y, and B may be assigned to X.

If a higher matching score indicates a higher degree of matching, a higher list score may indicate a better matching. On the contrary, if a lower matching score indicates a higher degree of matching, a lower list score may indicate a better matching.

Optionally, when there is no to-be-determined distribution person that has not been assigned any unassigned order group (e.g., when the number of unassigned order groups is greater than the number of distribution persons, and one distribution person can be assigned only one unassigned order group), some unassigned order groups may remain unassigned. In this case, the method may return back to step 101 for continuous execution.

In some embodiments, optionally, the obtaining an unassigned order group of each of at least two distribution businesses may include: obtaining the unassigned order group of each of the at least two distribution businesses every a preset scheduling time period. That is, distribution scheduling may be periodically performed to ensure distribution accuracy and distribution efficiency.

Certainly, in some embodiments, distribution scheduling may be performed in real time.

After an unassigned order group is obtained by grouping distribution orders, an unassigned tag may be set for the unassigned order group. An order group with the unassigned tag is an unassigned order group. In this way, the unassigned order group of each of the at least two distribution businesses may be obtained according to the unassigned tag. In some embodiments, optionally, the assigning the unassigned order group to a matched distribution person based on the distribution indicator and the status indicator may include: determining, based on the distribution indicator and the status indicator, a matched distribution person for the unassigned order group; and in response to a determining result that the unassigned order group meets a scheduling condition, assigning the unassigned order group to the matched distribution person.

That is, after a matching distribution person for an unassigned order group is determined, the unassigned order group is not immediately assigned to the matched distribution person. Instead, the unassigned order group may be assigned to the matched distribution person only after the unassigned order group meets a scheduling condition.

In some embodiments, the scheduling condition may be that the matched distribution person of the unassigned order group has completed his/her existing distribution orders. That is, an unassigned order group will be assigned to a matched distribution person only after the matched distribution person has completed his/her existing assigned distribution orders.

In some embodiments, the scheduling condition may be that a time difference between an expected completion time of the unassigned order group and a current time is less than a preset value (i.e., the current time is close to the expected completion time). In other words, an unassigned order group will be assigned to the matched distribution person only when a time difference between an expected completion time of the unassigned order group and a current time is less than a preset value.

After a current scheduling period ends, those unassigned order groups that have not met a scheduling condition (i.e., those that have not been assigned) may be returned back to the step of obtaining an unassigned order group for each of at least two distribution businesses for the next distribution scheduling.

In some embodiments, optionally, after an unassigned order group for each of at least two distribution businesses has been obtained, the method may further include: adding an unassigned order group that is similar to an assigned order group of a distribution person into the assigned order group according to a distance between a start address of the assigned order group and a start address of the unassigned order group, and a distance between a destination address of the assigned order group and a destination address of the unassigned order group. In this way, on-the-way distribution can be implemented to ensure distribution timeliness and distribution efficiency.

An assigned order group may refer to an order group that has been assigned to a distribution person.

In some embodiments, if a distance between start addresses of an unassigned order group and an assigned order group of a distribution person is less than a first distance threshold, and a distance between destination addresses of the unassigned order group and the assigned order group of the distribution person is less than a second distance threshold, the unassigned order group may be added into the assigned order group for the distribution person to perform distribution.

In some embodiments, a degree of order similarity between an assigned order group of a distribution person and an unassigned order group may be calculated according to a distance between start addresses of the assigned order group and unassigned order group, and a distance between destination addresses of the assigned order group and the unassigned order group.

An unassigned order group whose degree of order similarity is greater than a similarity threshold may be added into the assigned order group.

A shorter distance between start addresses and a shorter distance between destination addresses may indicate a higher degree of order similarity. For example, different scores may be preset according to different distance ranges. In this way, after a distance between start addresses of and a distance between destination addresses of an assigned order group and an unassigned order group are determined, a score corresponding to a distance range in which the distance between the start addresses falls may be determined and used as a first similarity degree score, and a score corresponding to a distance range in which the distance between the destination addresses falls may be determined and used as a second similarity degree score. A degree of order similarity may be calculated by, for example, adding, taking a weighted average of, or taking a weighted sum of the first similarity degree score and the second similarity degree score.

In addition, each unassigned order group may have an expected completion time. A third similarity degree score may be calculated according to a time difference between expected completion times of an unassigned order group and an assigned order group. For example, scores corresponding to different time value ranges may be preset and a score corresponding to a time value range in which the time difference falls may be determined and used as the third similarity degree score. The degree of order similarity may be calculated by, for example, adding, taking a weighted average of, or taking a weighted sum of the first similarity degree score, the second similarity degree score, and the third similarity degree score. In this way, an unassigned order group whose degree of order similarity is greater than the similarity threshold may be added into the assigned order group of a distribution person.

The distribution indicator of an unassigned order group may include a start address, a destination address, and/or an expected completion time. The start address or destination address may be determined according to an estimated distribution sequence of all distribution orders in the unassigned order group. A method to determine an estimated distribution sequence may vary with different distribution businesses. In some embodiments, the at least two distribution businesses may include a first distribution service and a second distribution service.

A distribution indicator of an unassigned order group of the first distribution service may be determined by the following steps.

First, an earliest expected completion time of all distribution orders in the unassigned order group may be assigned to an expected completion time of the unassigned order group; second, according to user addresses of all the distribution orders in the unassigned order group and the address of the distribution center, an estimated distribution sequence of all the distribution orders may be scheduled. Then, for the pickup type, a start address of a distribution order whose distribution is first performed may be assigned to a start address of the unassigned order group, and the address of the distribution center may be assigned to a destination address of the unassigned order group. For the delivery type, the address of the distribution center may be assigned to a start address of the unassigned order group, and a destination address of a distribution order whose distribution is last performed may be assigned to a destination address of the unassigned order group.

For the first distribution service, the estimated distribution sequence of all the distribution orders may be scheduled according to a minimal path principle, which may result in the shortest distribution path. That is, based on the minimal path principle, the distribution sequence will be determined so that a total path needed to complete all the distribution orders will be the shortest.

A distribution indicator of an unassigned order group of the second distribution service may be determined by the following steps.

First, an earliest expected completion time of all distribution orders in an unassigned order group may be assigned to an expected completion time for each distribution person corresponding to the unassigned order group; second, according to start addresses and destination addresses of all the distribution orders in the unassigned order group and an estimated distribution location of each distribution person, an estimated distribution sequence of each distribution person corresponding to all the distribution orders may be scheduled; and third, a start address of a distribution order whose distribution is first performed may be assigned to a start address of each distribution person corresponding to the unassigned order group, and a destination address of a distribution order whose distribution is last performed may be assigned to a destination address of each distribution person corresponding to the unassigned order group.

For an unassigned order group of the second distribution service, the distribution indicators for different distribution persons may be different.

In addition, the second distribution service may include a pickup operation of receiving a distribution object from a sender and a delivery operation of distributing a distribution object to a recipient. Therefore, the estimated distribution sequence may include a pickup sequence and a delivery sequence.

The pickup sequence may be determined according to start addresses of all distribution orders and an estimated distribution location of each distribution person. The delivery sequence may be determined according to destination addresses of all distribution orders and a start address of a distribution order for which pickup is last performed.

Therefore, a start address of a distribution order for which pickup is first performed may be used as a start address of a distribution person corresponding to the unassigned order group, and a destination address of a distribution order for which a delivery is last performed may be used as a destination address of a distribution person corresponding to the unassigned order group.

The second distribution service, especially the take-out distribution business, may have a relatively high requirement on the timeliness of the delivery and may generally expect an immediate delivery. Therefore, the pickup sequence of all distribution orders in an unassigned order group may be scheduled according to a pickup waiting time and the minimal path principle, so that a pickup path is the shortest while the pickup waiting time is the shortest. The delivery sequence may be scheduled according to an expected completion time and the minimal path principle, so that a delivery path is the shortest while an estimated completion time to complete the unassigned order group is less than or equal to the expected completion time.

An estimated completion time for a distribution person to complete the distribution of an unassigned order group may be determined in the following manner.

First, according to a distribution path of the unassigned order group, a moving speed of the distribution person, and a user waiting time of each distribution order, an estimated order completion time for the distribution person to complete each distribution order may be determined. The order completion time may be a specific moment (e.g., 15:30).

Second, the estimated completion time when the distribution person completes the unassigned order group may be calculated according to the order completion time.

If the estimated completion time is later than the expected completion time, the distribution path of the unassigned order group may be rerouted to ensure that the estimated completion time is earlier than or equal to the expected completion time and the distribution path is the shortest.

For the second distribution service, the distribution path may include a pickup path and a delivery path, and the user waiting time may include a pickup waiting time of a sender and a delivery waiting time of a recipient.

For the pickup type of the first distribution service, the user waiting time may include a pickup waiting time of a sender.

For the delivery type of the first distribution service, the user waiting time may include a delivery waiting time of a recipient.

For the first distribution service, an estimated completion time of an unassigned order group of the first distribution service and an order completion time of each distribution order in the unassigned order group may be calculated after the unassigned order group is assigned to a matched distribution person. For the second distribution service, an estimated completion time of each distribution person corresponding to an unassigned order group of the second distribution service and an order completion time of each distribution person corresponding to each distribution order may be calculated when a distribution indicator of the unassigned order group is determined. Certainly, the order completion time may also be calculated in advance for the unassigned order group of the first distribution service, so that the order completion time may be directly used after the unassigned order group is assigned to the distribution person.

The status indicator of a distribution person may include an estimated distribution time and an estimated distribution location.

In some embodiments, the estimated distribution time and the estimated distribution location of a distribution person may be determined by the following steps.

First, according to an assigned order group of the distribution person whose distribution is currently uncompleted, an estimated completion time of the assigned order group may be calculated and assigned to the estimated distribution time. A destination address of the assigned order group may be assigned to the estimated distribution location.

The assigned order group of a distribution person may be an order group that has been assigned to the distribution person according to the embodiments of this disclosure.

The estimated completion time may be a time when a distribution person can receive an unassigned order group, and the estimated distribution location may be a user location at the time when a distribution person can receive the unassigned order group.

The estimated completion time of an assigned order group may be determined according to a moving speed of the distribution person, a distribution path of the assigned order group, and a user waiting time of each distribution order in the assigned order group. The estimated completion time may be calculated by methods described in the foregoing embodiment before the assigned order group is assigned.

In some embodiments, the distribution indicator may include a start address, a destination address, and an expected completion time. The status indicator may include an estimated distribution time and an estimated distribution location. Then the assigning an unassigned order group to a matched distribution person based on the distribution indicator and the status indicator may include the following steps.

First, a matching score between the unassigned order group and each distribution person may be calculated according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group.

The degree of familiarity with the start address and the degree of familiarity with the destination address may be preset. Alternatively, a number of historical visits a distribution person made to the start address may be determined according to a historical distribution record of the distribution person, so as to determine the degree of familiarity with the start address. A larger number of historical visits may indicate a higher degree of familiarity. Likewise, a number of historical visits a distribution person made to the destination address may be determined according to a historical distribution record of the distribution person, so as to determine the degree of familiarity. A larger number of historical visits may indicate a higher degree of familiarity.

The priority of the unassigned order group may be determined according to a corresponding distribution business. For example, the second distribution service, which may have a relatively high distribution timeliness requirement, generally may have a higher priority, and the first distribution service, which may have a relatively low distribution timeliness requirement, generally may have a lower priority. The priority of the unassigned order group may also be determined according to an expected completion time of the unassigned order group. More specifically, the priority may be determined according to a time difference between a current moment and the expected completion time. A smaller time difference may indicate a higher priority.

For each aforementioned factor, a sub matching score may be calculated. Then the matching score between an unassigned order group and a distribution person may be calculated by adding, taking a weighted sum of, or taking a weighted average of the sub matching scores of one or more factors.

In some embodiments, scores corresponding to different distances may be preset. Then, according to a distance between the estimated distribution location of a distribution person and the start address of an unassigned order group, a corresponding score may be determined and used as a first sub matching score. For ease and clarity of description, “first”, “second”, “third”, and the like may be used to distinguish sub matching scores of different factors.

In some embodiments, scores corresponding to different time differences may be preset. Then, according to a time difference between the estimated distribution time and the expected arrival time of an unassigned order group, a corresponding score may be determined and used as a second sub matching score. According to the estimated completion time when distribution of an unassigned order group is completed, a score corresponding to a time difference between the estimated completion time and a current time may be determined and used as a third sub matching score.

In some embodiments, scores corresponding to different degrees of familiarity may be preset. Then, according to the degree of familiarity with the start address of an unassigned order group, a corresponding score may be determined and used as a fourth sub matching score. According to the degree of familiarity with the destination address of an unassigned order group, a corresponding score may be determined and used as a fifth sub matching score.

In some embodiments, scores corresponding to different priorities may be preset. Then, according to the priority of an unassigned order group, a corresponding sixth sub matching score may be determined.

Each unassigned order group may be assigned to a matched distribution person according to the matching scores.

The assigning an unassigned order group to a matched distribution person according to the matching score may include the following steps.

First, assuming there are N unassigned order groups, for each unassigned order group, treat the unassigned order group as the N^{th} to-be-determined unassigned order group. From to-be-determined distribution persons, a distribution person that has the highest degree of matching with the unassigned order group may be determined, which will result in M different matching lists. N is a total number of unassigned order groups and is an integer greater than or equal to 1, and M is an integer greater than or equal to 1.

Second, for each of the M matching lists, a sum of matching scores corresponding to all unassigned order groups may be calculated, which is a list score for each matching list.

Third, according to a matching list that has the best list score, the unassigned order group may be assigned to a corresponding distribution person.

An estimated completion time when a distribution person completes distribution of an unassigned order group may be determined with reference to the foregoing embodiment.

In the embodiments of this disclosure, distribution orders of a distribution business may be first grouped to obtain an unassigned order group of the distribution business. For distribution orders in the unassigned order group, a distance between start addresses of any two distribution orders may be less than a first distance, a distance between destination addresses of any two distribution orders may be less than a second distance, and/or a time difference between expected completion times of any two distribution orders may be less than a preset time.

Unassigned order groups of the at least two distribution businesses may be entered by an operation and maintenance person, or may be obtained from a business system of each of the at least two distribution businesses. The business system may be an online transaction system, and a distribution order may be generated according to a transaction order.

Distribution businesses of different distribution types may have different grouping methods for unassigned order groups.

In some embodiments, the at least two distribution businesses may include a first distribution service and a second distribution service. The obtaining an unassigned order group of the first distribution service may include the following steps.

First, a cluster center order may be selected according to a distance between a user address of an ungrouped distribution order of the first distribution service and an address of the distribution center.

Second, according to a distance between the user address of each ungrouped distribution order and a user address of the cluster center order, a clustering process may be performed to obtain the unassigned order group corresponding to the cluster center order.

For the pickup type, the user address may be an address of a sender. For the delivery type, the user address may be an address of a recipient.

By performing the clustering process, the cluster center order and a plurality of distribution orders whose user addresses are close to the user address of the cluster center order may be grouped into one group.

Optionally, a distribution order whose user address is farthest from the address of the distribution center may be selected from an ungrouped distribution order and used as the cluster center order.

To ensure grouping accuracy, a group capacity may be set. That is, a number of distribution orders included in an unassigned order group may be set. The group capacity may be used as a limit to perform the clustering process to obtain an unassigned order group.

In some embodiments, an unassigned order group of the second distribution service may be obtained by the following steps.

First, a start address, a destination address, and an expected completion time for each unassigned distribution order of the second distribution service may be determined.

Second, distribution orders may be grouped into a same unassigned order group, when a distance between start addresses of any two distribution orders is less than a first distance, a distance between destination addresses of any two distribution orders is less than a second distance, and a time difference between expected completion times of any two distribution orders is less than a preset time.

That is, a plurality of distribution orders that have close start addresses, close destination addresses, and close expected completion times may be grouped into a same unassigned order group.

A group capacity may be set to ensure grouping accuracy of unassigned order groups, and to ensure distribution scheduling accuracy.

In some embodiments, after an unassigned order group is assigned to a matched distribution person, the method may further include: for each assigned order group, determining an estimated order completion time for a matched distribution person to complete each distribution order in the assigned order group; and sending the order completion time of each distribution order to a sender terminal or a recipient terminal corresponding to each distribution order.

In addition, an inter-group distribution sequence of an assigned order group that is assigned to each distribution person may further be determined according to an assignment time sequence.

An estimated distribution sequence corresponding to a distribution person that has been assigned to each assigned order group may be used as an intra-group distribution sequence.

The distribution person may perform distribution of assigned order groups according to the inter-group distribution sequence, and may perform distribution of each assigned order group according to the intra-group distribution sequence.

The description in the foregoing embodiments may be referred for the estimated distribution sequence of an assigned order group.

An order group that has been assigned to a distribution person is an assigned order group of the distribution person.

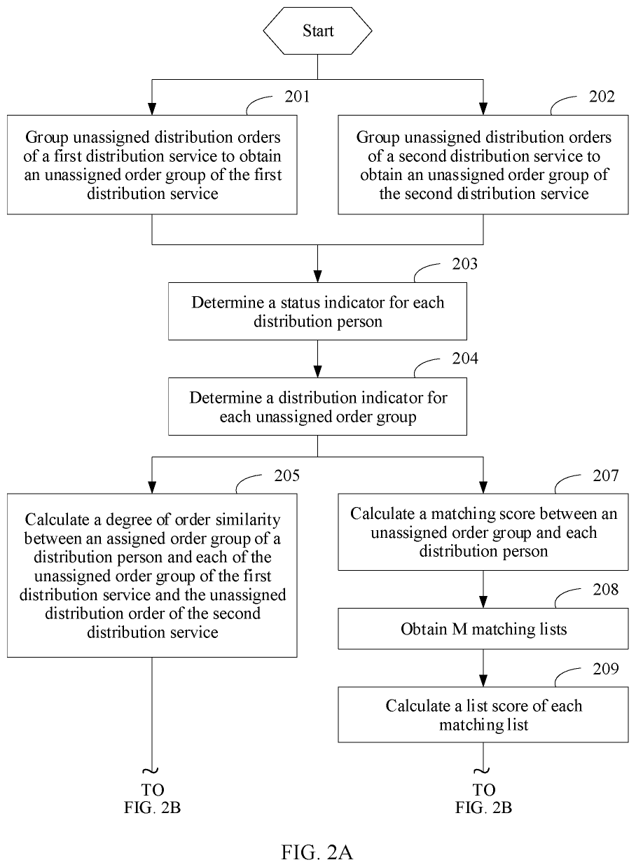

The technical solutions of this specification will be described below in details using an example in which the at least two distribution businesses are a first distribution service and a second distribution service. Referring to FIGS. 2A and 2B, the data processing method may include the following steps 201 through 214.

In step 201, unassigned distribution orders of the first distribution service may be grouped to obtain an unassigned order group of the first distribution service.

Optionally, step 201 may include:

selecting a cluster center order according to a distance between a user address of each ungrouped distribution order of the first distribution service and an address of an distribution center; and

performing a clustering process according to a distance between the user address of each ungrouped distribution order and a user address of the cluster center order, to obtain the unassigned order group corresponding to the cluster center order.

In step 202, unassigned distribution orders of the second distribution service may be grouped to obtain an unassigned order group of the second distribution service.

Optionally, step 202 may include: determining a start address, a destination address, and an expected completion time for each unassigned distribution order of the second distribution service; and

grouping distribution orders into a same unassigned order group, where a distance between start addresses of any two distribution orders is less than a first distance, a distance between destination addresses of any two distribution orders is less than a second distance, and a time difference between expected completion times of any two distribution orders is less than a preset time.

In step 203, a status indicator for each distribution person is determined.

The status indicator may include an estimated distribution location and an estimated distribution time.

The estimated distribution time may be determined in the following manner:

according to an assigned order group of the distribution person and whose distribution is currently uncompleted, assigning an estimated completion time of the assigned order group as the estimated distribution time.

The estimated distribution location is a destination address of the assigned order group.

In step 204, a distribution indicator for each unassigned order group may be determined.

The distribution indicator may include a start address, a destination address, and an expected completion time.

Optionally, step 204 may include:

for each unassigned order group of the first distribution service, assigning an earliest expected completion time of all distribution orders in the unassigned order group as an expected completion time of the unassigned order group;

scheduling, according to user addresses of the distribution orders in the unassigned order group and the address of the distribution center, an estimated distribution sequence of the distribution orders in the unassigned order group;

for the pickup type first distribution service, assigning a start address of a distribution order whose distribution is first performed to a start address of the unassigned order group, and assigning the address of the distribution center to a destination address of the unassigned order group; and

for the delivery type first distribution service, assigning the address of the distribution center to a start address of the unassigned order group, and assigning a destination address of a distribution order whose distribution is last performed to a destination address of the unassigned order group; and

for the unassigned order group of the second distribution service, assigning an earliest expected completion time of all distribution orders in the unassigned order group to an expected completion time for each distribution person corresponding to the unassigned order group;

scheduling, according to start addresses and destination addresses of the distribution orders in the unassigned order group and an estimated distribution location of each distribution person, an estimated distribution sequence of each distribution person corresponding to all the distribution orders; and

assigning a start address of a distribution order whose distribution is first performed to a start address of each distribution person corresponding to the unassigned order group, and assigning a destination address of a distribution order whose distribution is last performed to a destination address of each distribution person corresponding to the unassigned order group.

The estimated distribution sequence of the second distribution service may include a pickup sequence and a delivery sequence. Specifically, a start address of a distribution order for which pickup is first performed may be used as a start address of each distribution person corresponding to the unassigned order group, and a destination address of a distribution order for which a delivery is last performed may be used as a destination address of each distribution person corresponding to the unassigned order group.

In step 205, based on a distance between start addresses and a distance between destination addresses, a degree of order similarity between an assigned order group of each distribution person and each of the unassigned order group of the first distribution service and the unassigned distribution order of the second distribution service may be calculated.

In step 206, an unassigned order group that is of the first distribution service and whose degree of order similarity is greater than a similarity threshold and/or an unassigned distribution order that is of the second distribution service and whose degree of order similarity is greater than the similarity threshold may be added into the assigned order group of each distribution person.

For example, because the second distribution service usually may have a relatively high requirement on distribution timeliness and generally may require an on-time delivery, the degree of order similarity with the assigned order group may be calculated for an unassigned distribution order of the second distribution service, and the unassigned distribution order of the second distribution service may be added into the assigned order group as an on-the-way order.

In step 207, a matching score between each unassigned order group and each distribution person may be calculated according to the distribution indicator and the status indicator.

Optionally, step 207 may include:

calculating a matching score between an unassigned order group and each distribution person according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group.

Scores corresponding to different distances, different time differences, different degrees of familiarity, different priorities, and different estimated completion times may be set, so that a matching score may be calculated by adding the scores corresponding to one or more factors.

An estimated completion time when a distribution person completes distribution of an unassigned order group may be determined in the following manner.

First, according to a distribution path of the unassigned order group, a moving speed of the distribution person, and a user waiting time of each distribution order, an estimated order completion time when the distribution person completes each distribution order may be determined.

Second, according to the order completion time, the estimated completion time when each distribution person completes the unassigned order group may be calculated.

The distribution path of each unassigned order group may be corresponding to an estimated distribution sequence.

In step 208, assuming that there are N unassigned order groups, each unassigned order group may be treated as the N^{th} to-be-determined unassigned order group, a distribution person that has the highest degree of matching from the to-be-determined distribution persons may be determined, so as to obtain M matching lists. N is a total number of unassigned order groups and is an integer greater than or equal to 1.

In step 209, for each of the M matching lists, a sum of matching scores corresponding to all unassigned order groups may be calculated, which may be used as a list score of each matching list.

In step 210, each unassigned order group may be assigned to a corresponding distribution person according to a matching list that has the best list score.

In step 211, according to an assignment time sequence, an inter-group distribution sequence of an assigned order group assigned to each distribution person may be determined.

In step 212, for each assigned order group, an estimated distribution sequence corresponding to a matched distribution person may be used as an intra-group distribution sequence.

In step 213, for each assigned order group, an estimated order completion time when the matched distribution person completes each distribution order may be determined.

In step 214, the order completion time of each distribution order may be sent to a sender terminal or a recipient terminal corresponding to the distribution order.

The sender terminal or the recipient terminal may be an electronic device, such as a mobile phone or a tablet, that can receive or inquiry related distribution information of an order.

In an actual application, the first distribution service may be a warehouse-to-home delivery business, and the second distribution service may be a take-out distribution business. Distribution orders of the warehouse-to-home delivery business and the take-out distribution business may be jointly scheduled to implement staggered distribution. In addition, a same batch of distribution persons may be shared to reduce distribution costs. With joint scheduling, the system can directly assign an unassigned order group to a matched distribution person, without resorting to conventional manual sorting, thereby reducing dependency on skilled labor. It does not rely on a distribution mode in which a single distribution person is responsible for one region, thereby increasing distribution efficiency, and reducing resource waste caused by the redundancy in distribution persons.

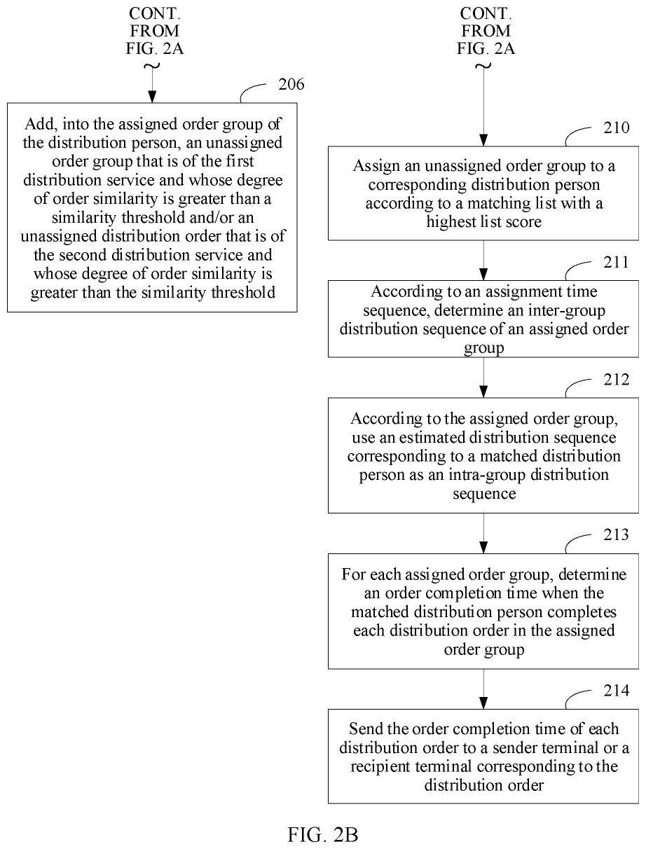

FIG. 3 is a schematic structural diagram of a data processing apparatus according to one embodiment of this disclosure. Referring to FIG. 3, the apparatus may include: an order obtaining module 301, configured to obtain an unassigned order group of each of at least two distribution businesses; a first indicator determining module 302, configured to determine a status indicator for each of one or more distribution persons; a second indicator determining module 303, configured to determine a distribution indicator for each of the unassigned order groups; and a first order assigning module 304, configured to assign the unassigned order group to a matched distribution person based on the distribution indicators and the status indicators.

In this embodiment, distribution orders of at least two distribution businesses may be jointly scheduled to share a same batch of distribution persons, so that distribution costs may be greatly reduced, and distribution workload may be balanced. A distribution order can be assigned to a suitable distribution person based on the distribution indicators and the status indicators. The scheduling may be automatic and may achieve maximum distribution efficiency, without resorting to manual sorting. When the at least two distribution businesses include the first distribution service and the second distribution service, because they have different distribution peak hours, distribution capacities for one distribution business may complement the other at different time periods, so that distribution workload may be more efficiently distributed.

Optionally, the first order assigning module may include: an order determining unit, configured to determine, based on the distribution indicators and the status indicators, a distribution person matching the unassigned order group; and an order matching unit, configured to: in response to a determining result that the unassigned order group meets a scheduling condition, assign the unassigned order group to a matched distribution person.

In some embodiments, the scheduling condition may be that distribution of an assigned order group of the distribution person matching the unassigned order group has been completed.

In some embodiments, the scheduling condition may be that a time difference between an expected completion time of the unassigned order group and a current time is less than a preset value. That is, the current time is close to the expected completion time.

In some embodiments, the apparatus may further include: a second order assigning module, configured to add an unassigned order group similar to an assigned order group of a distribution person into the assigned order group according to a distance between start addresses and a distance between destination addresses.

In some embodiments, the first order assigning module may be configured to:
calculate a matching score between the unassigned order group and each distribution person according to the distribution indicators and the status indicators; and assign the unassigned order group to a matched distribution person according to the matching score.

A globally optimal solution may be used to determine a distribution person that is matched to an unassigned order group in the following steps. First, assuming that there are N unassigned order groups, for each unassigned order group, treat the unassigned order group as the N^{th} to-be-determined unassigned order group. A distribution person that has the highest degree of matching with the unassigned order group may be determined from the to-be-determined distribution persons, which may result in M matching lists, where N is a total number of unassigned order groups and is an integer greater than or equal to 1, M is an integer greater than or equal to 1; and M≤N*(N−1)*(N−2)*−2*1. For each of the M matching lists, a sum of matching scores corresponding to all unassigned order groups may be calculated to obtain a list score for each matching list. Then each unassigned order group may be assigned to a corresponding distribution person according to a matching list that has the best list score.

In some embodiments, the order obtaining module may be configured to obtain the unassigned order group of each of the at least two distribution businesses every a preset scheduling time period.

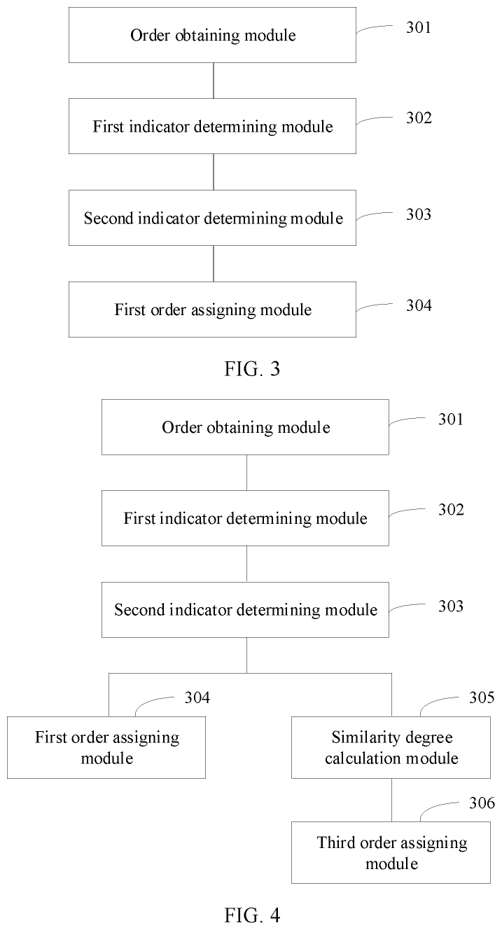

FIG. 4 shows a data processing apparatus according to one embodiment of this disclosure. The difference between the embodiments shown in FIG. 3 and that in FIG. 4 is that, in the embodiment of FIG. 4, the at least two distribution businesses may include a first distribution service and a second distribution service.

Distribution types of the first distribution service may include a delivery type in which a distribution object may be collected from a distribution center and delivered to a recipient, and a pickup type in which a distribution object may be collected from a sender and delivered to the distribution center. The second distribution service may have a distribution type in which a distribution object is received from a sender and distributed to a recipient.

The apparatus may further include a similarity degree calculation module 305 and a third order assigning module 306.

The similarity degree calculation module 305 may be configured to: based on a distance between start addresses and a distance between destination addresses, a degree of order similarity between an assigned order group of each distribution person and each of an unassigned order group of the first distribution service and an unassigned distribution order of the second distribution service.

The third order assigning module 306 may be configured to add, into the assigned order group of each distribution person, an unassigned order group that is of the first distribution service and whose degree of order similarity is greater than a similarity threshold and/or an unassigned distribution order that is of the second distribution service and whose degree of order similarity is greater than the similarity threshold.

Optionally, the apparatus may further include a first order classification module and a second order classification module.

The first order classification module may be configured to select a cluster center order according to a distance between a user address of an ungrouped distribution order of the first distribution service and an address of a distribution center; and to perform, according to a distance between the user address of the ungrouped distribution order and a user address of the cluster center order, a clustering process to obtain an unassigned order group corresponding to the cluster center order.

The second order classification module may be configured to determine a start address, a destination address, and an expected completion time of an unassigned distribution order of the second distribution service; and to group distribution orders into a same unassigned order group, where a distance between start addresses of any two distribution orders is less than a first distance, a distance between destination addresses of any two distribution orders is less than a second distance, and a time difference between expected completion times of any two distribution orders is less than a preset time.

Optionally, the distribution indicator may include a start address, a destination address, and an expected completion time; and the first indicator determining module may include a first determining unit and a second determining unit.

The first determining unit may be configured to: for each unassigned order group of the first distribution service, use an earliest expected completion time of all distribution orders in the unassigned order group as an expected completion time of the unassigned order group; schedule, according to user addresses of all the distribution orders in the unassigned order group and the address of the distribution center, an estimated distribution sequence of all the distribution orders; for the pickup type, use a start address of a distribution order whose distribution is first performed as a start address of the unassigned order group, and use the address of the distribution center as a destination address of the unassigned order group; and for the delivery type, use the address of the distribution center as a start address of the unassigned order group, and use a destination address of a distribution order whose distribution is last performed as a destination address of the unassigned order group.

The second determining unit may be configured to: for each unassigned order group of the second distribution service, use an earliest expected completion time of all distribution orders in the unassigned order group as an expected completion time for each distribution person corresponding to the unassigned order group; schedule, according to start addresses and destination addresses of all the distribution orders in the unassigned order group and an estimated distribution location of each distribution person, an estimated distribution sequence of each distribution person corresponding to all the distribution orders; and use a start address of a distribution order whose distribution is first performed as a start address of each distribution person corresponding to the unassigned order group, and use a destination address of a distribution order whose distribution is last performed as a destination address of each distribution person corresponding to the unassigned order group.

Optionally, a status indicator of each distribution person may include an estimated distribution time and an estimated distribution location; and the first order assigning module may include a first calculation unit and a first order matching unit.

The first calculation unit may be configured to calculate a matching score between each unassigned order group and each distribution person according to one or more factors including a distance between the estimated distribution location of each distribution person and the start address of each unassigned order group, a time difference between the estimated distribution time and an expected arrival time of each unassigned order group, a degree of familiarity with the start address of each unassigned order group, a degree of familiarity with the destination address of each unassigned order group, an estimated completion time when distribution of each unassigned order group is completed, and a priority of each unassigned order group.

The first order assigning unit may be configured to assign each unassigned order group to a matched distribution person according to the matching score.

Optionally, the first order assigning unit may be configured to: use each unassigned order group as the N^{th} to-be-determined unassigned order group, and determine, from to-be-determined distribution persons, a distribution person who has a highest degree of matching with each unassigned order group, to obtain M matching lists, where N is a total number of unassigned order groups and is an integer greater than or equal to 1, and M is an integer greater than or equal to 1;

for each matching list, calculate the sum of matching scores corresponding to all the unassigned order groups to obtain the list score for each matching list; and

match each unassigned order group to a corresponding distribution person according to the match list that has the best list score.

Optionally, the second indicator determining module may be configured to: according to an assigned order group that is of the distribution person and whose distribution is currently uncompleted, use an estimated completion time of the assigned order group as the estimated distribution time, and use a destination address of the assigned order group as the estimated distribution location.

Optionally, the apparatus may further include a first time determining unit and a second time determining unit.

The first time determining module may be configured to: determine, according to a distribution path of each unassigned order group, a moving speed of each distribution person, and a user waiting time of each distribution order, an estimated order completion time when each distribution person completes each distribution order.

The second time determining module may be configured to calculate, according to the order completion time, the estimated completion time when each distribution person completes each unassigned order group.

Optionally, the apparatus may further include a third time determining module and a time remaining module.

The third time determining module may be configured to: determine an estimated order completion time when a distribution person matching each assigned order group completes each distribution order in each assigned order group.

The time reminding module may be configured to send the order completion time of each distribution order to a sender terminal or a recipient terminal corresponding to each distribution order.

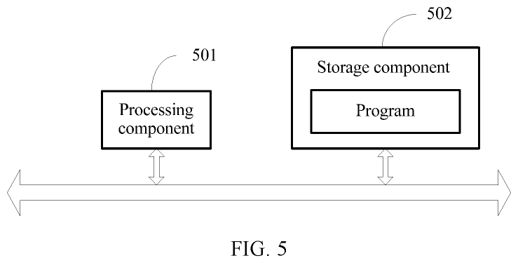

Internal functions and a structure of the data processing apparatus are described above. In a possible design, the structure of the data processing apparatus may be implemented as a data processing device. As shown in FIG. 5, the processing device may include a processing component 501 and a storage component 502.

The storage component 502 may be configured to store a program that supports the data processing apparatus to execute the data processing method in any one of the foregoing embodiments. The processing component 501 may be configured to execute the program stored in the storage component 502.

The storage component 502 may be configured to store one or more computer instructions, where the one or more computer instructions may be executed by the processing component 501.

The processing component 501 may be configured to obtain an unassigned order group for each of at least two distribution businesses;

determine a status indicator for each of one or more distribution persons;

determine a distribution indicator for each of the unassigned order groups; and

assign the unassigned order group to a matched distribution person based on the distribution indicators and the status indicators.

Optionally, the processing component 501 may be further configured to execute all or some steps in the foregoing method.

A structure of the data processing device may further include a communications interface, configured to perform communication between the data processing device and another device or communications network.

An example embodiment of this disclosure may further provide a computer storage medium, configured to store a computer software instruction used by the data processing apparatus. The computer software instruction may include a program for executing the data processing method in any one of the foregoing embodiments.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

The described apparatus embodiment is merely an example. The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments. A person of ordinary skill in the art may understand and implement the embodiments of this disclosure without creative efforts.

Based on the foregoing descriptions of the implementations, a person skilled in the art may clearly understand that each implementation may be implemented by software in addition to a necessary general hardware platform or by hardware. Based on such an understanding, the foregoing technical solutions essentially or the part contributing to related technologies may be implemented in a form of a software product. The computer software product is stored in a computer readable storage medium, such as a ROM/RAM, a magnetic disk, or an optical disc, and includes several instructions for instructing a computer device (which may be a personal computer, a server, a network device, or the like) to perform the methods described in the embodiments or some parts of the embodiments.

Finally, it should be noted that the foregoing embodiments are merely intended for describing the technical solutions of this disclosure other than limiting this disclosure. Although this disclosure is described in detail with reference to the foregoing embodiments, a person of ordinary skill in the art should understand that the person may still make modifications to the technical solutions described in the foregoing embodiments or make equivalent replacements to some technical features thereof, without departing from the spirit and scope of the technical solutions of the embodiments of this disclosure.

What is claimed is:

1. A data processing method, comprising:
obtaining an unassigned order group for each of at least two distribution businesses, the unassigned order groups each comprising at least one distribution order;
determining a status indicator for each of one or more distribution persons;
determining a distribution indicator for each of the unassigned order groups; and
assigning, based on the status indicators and the distributions indicators, each of the unassigned order groups to a matched distribution person from the one or more distribution persons,
wherein assigning an unassigned order group to a matched distribution person from the one or more distribution persons comprises:
computing, based on the status indicators and the distribution indicators, a matching score between the unassigned order group and each of the one or more distribution persons; and
assigning, based on the matching scores, the unassigned order group to the matched distribution person.

2. The method of claim 1, wherein assigning the unassigned order group to the matched distribution person from the one or more distribution persons comprises:
determining, based on the status indicators and the distribution indicators, the matched distribution person for the unassigned order group; and
in response to a determining result that the unassigned order group meets a scheduling condition, assigning the unassigned order group to the matched distribution person.

3. The method of claim 1, further comprising:
adding an unassigned order group similar to an assigned order group of a distribution person into the assigned order group according to a distance between a start address of the assigned order group and a start address of the unassigned order group, and a distance between a destination address of the assigned order group and a destination address of the unassigned order group.

4. The method of claim 1, wherein the at least two distribution businesses comprise a first distribution service and a second distribution service.

5. The method of claim 1, wherein the at least two distribution businesses comprise a first distribution service and a second distribution service,
wherein distribution types of the first distribution service include a delivery type in which a distribution object is collected from a distribution center and delivered to a recipient, and a pickup type in which a distribution object is collected from a sender and delivered to the distribution center,
and wherein the second distribution service has a distribution type in which a distribution object is received from a sender and delivered to a recipient.

6. The method of claim 5, wherein obtaining an unassigned order group of the first distribution service comprises:
selecting, according to a distance between a user address of each ungrouped distribution order of the first distribution service and an address of the distribution center, a cluster center order; and
performing, according to a distance between the user address of each ungrouped distribution order and a user address of the cluster center order, a clustering process to obtain the unassigned order group corresponding to the cluster center order.

7. The method of claim 5, wherein obtaining an unassigned order group of the second distribution service comprises:
determining a start address, a destination address, and an expected completion time for each unassigned distribution order of the second distribution service; and
grouping unassigned distribution orders into the unassigned order group of the second distribution service, wherein a distance between start addresses of any two distribution orders in the unassigned order group is less than a first distance, a distance between destination addresses of any two distribution orders in the unassigned order group is less than a second distance, and a time difference between expected completion times of any two distribution orders in the unassigned order group is less than a preset time.

8. The method of claim 5, wherein the distribution indicator comprises a start address, a destination address, and an expected completion time,
and wherein determining a distribution indicator for an unassigned order group of the first distribution service comprises:
assigning an earliest expected completion time of all distribution orders in the unassigned order group to an expected completion time of the unassigned order group;
scheduling, according to user addresses of the distribution orders in the unassigned order group and an address of the distribution center, an estimated distribution sequence of the distribution orders in the unassigned order group;
for the pickup type first distribution service, assigning a start address of a distribution order whose distribution is first performed to a start address of the unassigned order group, and assigning the address of the distribution center to a destination address of the unassigned order group; and
for the delivery type first distribution service, assigning the address of the distribution center to a start address of the unassigned order group, and assigning a destination address of a distribution order whose distribution is last performed to a destination address of the unassigned order group,
and wherein determining a distribution indicator for an unassigned order group of the second distribution service comprises:
assigning an earliest expected completion time of distribution orders in the unassigned order group to an expected completion time of a distribution person corresponding to the unassigned order group;
scheduling, according to start addresses and destination addresses of the distribution orders in the unassigned order group and an estimated distribution location of each distribution person, an estimated distribution sequence for each distribution person corresponding to the distribution orders; and
assigning a start address of a distribution order whose distribution is first performed to a start address of each distribution person corresponding to the unassigned order group, and assigning a destination address of a distribution order whose distribution is last performed to a destination address of each distribution person corresponding to the unassigned order group.

9. The method of claim 8, wherein the status indicator of a distribution person comprises an estimated distribution time and an estimated distribution location,
and wherein assigning an unassigned order group to a matched distribution person based on the distribution indicators and the status indicators comprises:
calculating a matching score between the unassigned order group and each distribution person according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group; and
assigning, based on the matching scores, the unassigned order group to the matched distribution person.

10. The method of claim 9, wherein assigning an unassigned order group to a matched distribution person based on the distribution indicators and the status indicators comprises:
treating the unassigned order group as the N^{th} to-be-determined unassigned order group, and determining, from to-be-determined distribution persons, the distribution person who has a highest degree of matching with the unassigned order group to obtain M matching lists, wherein N is a total number of unassigned order groups and is an integer greater than or equal to 1, and M is an integer greater than or equal to 1;
for each of the M matching lists, calculating a sum of the matching scores corresponding to all unassigned order groups to obtain a list score for each matching list; and
assigning, based on a matching list with a highest list score, the unassigned order group to a corresponding distribution person.

11. The method of claim 9, wherein determining the estimated distribution time and the estimated distribution location of a distribution person comprises:
assigning, according to an assigned order group that is of the distribution person and whose distribution is currently uncompleted, an estimated completion time of the assigned order group to the estimated distribution time, and a destination address of the assigned order group to the estimated distribution location.

12. The method of claim 9, wherein determining an estimated completion time of a distribution person completes distribution of an unassigned order group comprises:
determining, according to a distribution path of the unassigned order group, a moving speed of the distribution person, and a user waiting time of each distribution order in the unassigned order group, an estimated order completion time of each distribution order; and
calculating, according to the order completion times, the estimated completion time of the unassigned order group.

13. The method of claim 12, after the assigning the unassigned order group to a matched distribution person based on the distribution indicators and the status indicators, further comprising:
determining the estimated order completion time of each distribution order in the assigned order group; and
sending the order completion time of each distribution order to a sender terminal or a recipient terminal corresponding to the distribution order.

14. The method of claim 5, further comprising:
calculating, based on a distance between start addresses and a distance between destination addresses, a degree of order similarity between an assigned order group of each distribution person and each of the unassigned order group of the first distribution service and the unassigned distribution orders of the second distribution service; and
adding, into the assigned order group, an unassigned order group that is of the first distribution service and whose degree of order similarity is greater than a similarity threshold and/or an unassigned distribution order that is of the second distribution service and whose degree of order similarity is greater than the similarity threshold.

15. A data processing apparatus, comprising:
an order obtaining module, configured to obtain an unassigned order group for each of at least two distribution businesses, the unassigned order groups each comprising at least one distribution order;
a first indicator determining module, configured to determine a status indicator for each of one or more distribution persons;
a second indicator determining module, configured to determine a distribution indicator for each of the unassigned order groups; and
a first order assigning module, configured to assign, based on the status indicators and the distribution indicators, each of the unassigned order groups to a matched distribution person from the one or more distribution persons,
wherein the first order assigning module is configured to:
compute, based on the status indicators and the distribution indicators, a matching score between the unassigned order group and each of the one or more distribution persons; and
assign, based on the matching scores, the unassigned order group to the matched distribution person.

16. The apparatus of claim 15, wherein the first order assigning module comprises:
an order determining unit, configured to:
determine, based on the status indicators and the distribution indicators, the matched distribution person for the unassigned order group; and
an order assigning unit, configured to:
in response to a determining result that the unassigned order group meets a scheduling condition, assign the unassigned order group to the matched distribution person.

17. The apparatus of claim 15, further comprising:
a second order assigning module, configured to:
add an unassigned order group similar to an assigned order group of a distribution person into the assigned order group according to a distance between a start address of the assigned order group and a start address of the unassigned order group, and a distance between a destination address of the assigned order group and a destination address of the unassigned order group.

18. The apparatus of claim 15, wherein the at least two distribution businesses comprise a first distribution service and a second distribution service.

19. The apparatus of claim 15, wherein the at least two distribution businesses comprise a first distribution service and a second distribution service,
wherein a distribution period of the first distribution service is greater than a distribution period of the second distribution service, and the first distribution service and the second distribution service have different distribution peak hours,
wherein distribution types of the first distribution service include a delivery type in which a distribution object is collected from a distribution center and delivered to a recipient, and a pickup type in which a distribution object is collected from a sender and delivered to the distribution center,
and wherein the second distribution service has a distribution type in which a distribution object is received from a sender and delivered to a recipient.

20. The apparatus of claim 19, further comprising:
a first order classification module, configured to:
select, according to a distance between a user address of each ungrouped distribution order of the first distribution service and an address of the distribution center, a cluster center order; and
perform, according to a distance between the user address of each ungrouped distribution order and a user address of the cluster center order, a clustering process to obtain the unassigned order group corresponding to the cluster center order.

21. The apparatus of claim 19, further comprising:
a second order classification module, configured to:
determine a start address, a destination address, and an expected completion time for each unassigned distribution order of the second distribution service; and
group unassigned distribution orders into the unassigned order group of the second distribution service, wherein a distance between start addresses of any two distribution orders in the unassigned order group is less than a first distance, a distance between destination addresses of any two distribution orders in the unassigned order group is less than a second distance, and a time difference between expected completion times of any two distribution orders in the unassigned order group is less than a preset time.

22. The apparatus of claim 19, wherein the distribution indicator comprises a start address, a destination address, and an expected completion time,
and wherein the first indicator determining module comprises:
a first determining unit, configured to, for each unassigned order group of the first distribution service:
assign an earliest expected completion time of distribution orders in the unassigned order group to an expected completion time of the unassigned order group;
schedule, according to user addresses of the distribution orders in the unassigned order group and an address of the distribution center, an estimated distribution sequence of the distribution orders in the unassigned order group;
for the pickup type first distribution service, assign a start address of a distribution order whose distribution is first performed to a start address of the unassigned order group, and assign the address of the distribution center to a destination address of the unassigned order group; and
for the delivery type first distribution service, assign the address of the distribution center to a start address of the unassigned order group, and assign a destination address of a distribution order whose distribution is last performed to a destination address of the unassigned order group; and
a second determining unit, configured to, for each unassigned order group of the second distribution service:
assign an earliest expected completion time of distribution orders in the unassigned order group to an expected completion time for a distribution person corresponding to the unassigned order group;
schedule, according to start addresses and destination addresses of the distribution orders in the unassigned order group and an estimated distribution location of each distribution person, an estimated distribution sequence of each distribution person corresponding to the distribution orders; and
assign a start address of a distribution order whose distribution is first performed to a start address of each distribution person corresponding to the unassigned order group, and assign a destination address of a distribution order whose distribution is last performed to a destination address of each distribution person corresponding to the unassigned order group.

23. The apparatus of claim 22, wherein the status indicator of a distribution person comprises an estimated distribution time and an estimated distribution location,
and wherein the first order assigning module comprises:
a first calculation unit, configured to:
calculate a matching score between the unassigned order group and each distribution person according to one or more factors including a distance between the estimated distribution location of each distribution person and the start address of the unassigned order group, a time difference between the estimated distribution time and an expected arrival time of the unassigned order group, a degree of familiarity with the start address of the unassigned order group, a degree of familiarity with the destination address of the unassigned order group, an estimated completion time of the unassigned order group, and a priority of the unassigned order group; and
a first order matching unit, configured to assign, based on the matching scores, the unassigned order group to the matched distribution person.

24. The apparatus of claim 22, wherein the first order matching unit is configured to, for each unassigned order group:
treat the unassigned order group as the N^{th} to-be-determined unassigned order group, and determine, from to-be-determined distribution persons, the distribution person who has a highest degree of matching with the unassigned order group to obtain M matching lists, wherein N is a total number of unassigned order groups and is an integer greater than or equal to 1, and M is an integer greater than or equal to 1;
for each of the M matching lists, calculate a sum of the matching scores corresponding to all unassigned order groups to obtain a list score for each matching list; and
assign, based on a matching list with the best list score, the unassigned order group to a corresponding distribution person.

25. The apparatus of claim 23, wherein the second indicator determining module is configured to:
assign, according to an assigned order group that is of the distribution person and whose distribution is currently uncompleted, an estimated completion time of the assigned order group to the estimated distribution time, and a destination address of the assigned order group to the estimated distribution location.

26. The apparatus of claim 23, further comprising:
a first time determining module, configured to:
determine, according to a distribution path of each unassigned order group, a moving speed of the distribution person, and a user waiting time of each distribution order in the unassigned order group, an estimated order completion time of each distribution order; and
a second time determining module, configured to:
calculate, according to the order completion times, the estimated completion time of the unassigned order group.

27. The apparatus of claim 26, further comprising:
a third time determining module, configured to:
determine the estimated order completion time of each distribution order in the assigned order group; and
a time reminding module, configured to:
send the order completion time of each distribution order to a sender terminal or a recipient terminal corresponding to the distribution order.

28. The apparatus of claim 19, further comprising:
a similarity degree calculation module, configured to:
compute, based on a distance between start addresses and a distance between destination addresses, a degree of order similarity between an assigned order group of each distribution person and each of the unassigned order group of the first distribution service and the unassigned distribution order of the second distribution service; and
a third order assigning module, configured to:
add, into the assigned order group, an unassigned order group of the first distribution service whose degree of order similarity is greater than a similarity threshold and/or an unassigned distribution order that is of the second distribution service and whose degree of order similarity is greater than the similarity threshold.

29. A data processing device, comprising a processing component and a storage component,
wherein the storage component is configured to store one or more computer instructions, and wherein the one or more computer instructions are executed by the processing component to:
obtain an unassigned order group for each of at least two distribution businesses, the unassigned order groups each comprising at least one distribution order;
determine a status indicator for each of one or more distribution persons;
determine a distribution indicator for each of the unassigned order group; and
assign, based on the status indicators and the distribution indicators, each of the unassigned order groups to a matched distribution person from the one or more distribution persons,
wherein assigning an unassigned order group to a matched distribution person from one of more distribution persons comprises:
computing, based on the status indicators and the distribution indicators, a matching score between the unassigned order group and each of the one or more distribution persons; and
assigning, based on the matching scores, the unassigned order group to the matched distribution person.
